(19) United States
(12) Patent Application Publication
(10) Pub. No.: US 2025/0305316 A1
(43) Pub. Date: Oct. 2, 2025

(54) STRUCTURAL SLIDING BEARING

(71) Applicant: Maurer Engineering GmbH, Munich (DE)

(72) Inventors: Felix WEBER, Pfaffhausen (CH); Leopold MEIER, Munich (DE); Frederik BOMHOLT, Fahrenzhausen (DE)

(21) Appl. No.: 18/864,498

(22) PCT Filed: Mar. 2, 2023
(86) PCT No.: PCT/EP2023/055328

§ 371 Date: Nov. 8, 2024

(30) Foreign Application Priority Data
May 9, 2022 (DE) 10 2022 204 542.4

(51) Int. Cl. E04H 9/02

(52) U.S. Cl. CPC E04H 9/021

(57) ABSTRACT

The present invention relates to a structural sliding bearing (1) having at least one sliding surface (2) with a sliding plate (3) and a mating surface which are in sliding contact so that the sliding plate (3) can move relative to the at least one mating surface, and the mating surface is arranged on a backing plate (4), wherein the mating surface is formed as a sliding sheet (5). The sliding sheet (5) is configured to have a sliding sheet protrusion 6 which projects at least partially beyond the backing plate (4). Further embodiments of the invention provide for arrangements as an earthquake protection device and as a spherical plain bearing.

The present invention relates to a structural sliding bearing comprising at least one sliding surface having a sliding plate and a mating surface which are in sliding contact such that the sliding plate can slide relative to the at least one mating surface, and the mating surface is arranged on a backing plate, wherein the mating surface is formed as a sliding sheet.

Such structural sliding bearings have been known for a long time. They are used in structures, for example buildings, industrial plants, and bridges, to support them or parts of the structures, such as the bridge deck on abutments or supports. Also, certain structural forms can be used as earthquake protection devices to reduce the shear forces of an earthquake on the structure. The basic requirements for the planning, design, and construction of structural bearings are regulated in Europe in EN 1990 and EN 1337 respectively. As far as earthquake protection devices are concerned, these are regulated in EN 1998 and EN 15129.

Here, by a sliding surface a combination of a sliding plate and a mating surface is meant that allows relative displacements. A sliding plate typically consists of a sliding material, for example PTFE, UHMWPE, or another material, which has the desired, usually low, frictional properties. The mating surface consists of a material which, in combination with the sliding material of the sliding plate, ensures the desired frictional properties in the sliding surface. The mating surface usually consists of a chromium-plated steel surface or a sliding sheet, which is made of stainless steel, for example, or is coated or otherwise treated in such a way that it has the desired sliding properties in combination with the sliding plate. Sliding plate and mating surface do not have to be flat. Particularly, in earthquake protection devices they are usually spherically curved.

A backing plate is understood to be a metallic component for supporting the sliding plate or the mating surface, with which the structural sliding bearing is attached to the structure. The backing plate can also be used at least partially as a mating surface, namely if the surface of the backing plate is machined or treated in such a way that it ensures the desired sliding properties in combination with a sliding plate sliding on it. For example, a chromium-plated steel surface of the backing plate can also be used as a mating surface.

Structural sliding bearings are designed both for displacements that occur in the use condition and for displacements that occur as a result of events that are irregular and do not necessarily have to occur during the service life of a structural bearing. EN 1990 defines limit states up to which certain properties of a structure or its structural bearings must be ensured. The serviceability limit state comprises load cases that correspond to normal conditions of use and do not cause any damage to the structure. In contrast, the ultimate limit state comprises load cases that correspond to extreme events. The extreme events can be, for example, earthquakes, fires, explosions or an impact on the structure. The ultimate limit state ensures the load-bearing capacity of the structure during such extreme events so that the structure does not fail. Here, damage may occur within certain limits. The limit states must be determined individually for the respective structures and structural bearings, as they depend, for example, on the type of structure and the expected load cases and can be very different. Ultimately, they represent the requirements that the respective structural sliding bearing must fulfil. For example, it must have a displacement capacity that corresponds to the expected displacement of the structure for the respective limit state.

The known structural sliding bearings are thus dimensioned in cooperation by the designer of the structure and the designer of the structural bearing so that they fulfil the respective requirements in the two basic states mentioned above. However, structural bearings with large differences between the displacements in the serviceability limit state and those in the ultimate limit state are dimensioned relatively large. This is because until now it has been assumed, to be on the safe side, that the bearings must have sufficient displacement capacity in the ultimate limit state and that in this state the backing plate still supports full-surface the mating surface. This leads to relatively large backing plates and can be a disadvantage if there is limited space at the installation location of the bearing. Furthermore, relatively large dimensioned structural sliding bearings are associated with correspondingly high costs.

The invention is therefore based on the problem of providing a structural sliding bearing which has a more compact design and is less expensive to manufacture, while maintaining the same level of safety.

The solution to the problem is achieved with a generic structural sliding bearing which, according to the invention, has a sliding sheet with a sliding sheet protrusion which projects at least partially beyond the backing plate. The sliding sheet is thus not completely supported by the backing plate, but at least partially protrudes at the sides. The term sliding sheet protrusion is not to be understood restrictively. The sliding sheet can at its edge both hang or stand over the backing plate, i.e. it can be realized, for example, as a sliding sheet protrusion or sliding sheet projection.

The solution according to the invention is based on the finding that the backing plate can be dimensioned smaller without compromising the safety of the bearing while maintaining the same displacement capacity. However, this is only possible if the sliding sheet is at least partially larger than the backing plate. The applicant's investigations have shown that it is precisely the protrusion of the sliding sheet that leads to the effect that the sliding plate does not suffer as much as previously assumed when it is pushed beyond the edge of the backing plate. On the part of the applicant, this is explained by the fact that in the area of the sliding sheet protrusion, precisely because of the sliding sheet, there is not a sharp edge on which the sliding plate can get caught or on which it is planed off. The sliding sheet prevents or covers a sharp edge with its protrusion. The backing plate can therefore be made somewhat smaller. The structural sliding bearing according to the invention can therefore be manufactured more cost-effectively than a conventional structural sliding bearing with the same displacement capacity.

In other words, the structural sliding bearing according to the invention offers increased displacement capacity compared with a conventional bearing having a backing plate of the same size.

Further executed, the structural sliding bearing is designed as an earthquake protection device or earthquake isolator. Thus, the structural sliding bearing is designed in such a way that it at least reduces the effect of an earthquake on a structure. This is done, for example, by using curved sliding surfaces that allow a pendulum movement of the structure. This pendulum movement due to the earthquake then leads to the fact that the fundamental vibration period of the structure no longer lies in the period range of the greatest earthquake energy and that the energy of the earthquake is dissipated in the sliding bearing of the structure.

Alternatively or additionally, the backing plate is dimensioned so large that, in the serviceability limit state of the structural sliding bearing, the sliding plate is in full-surface contact with a portion of the sliding sheet in the event of a maximum lateral displacement, in which portion the sliding sheet is still supported full-surface by the backing plate. The sliding plate of the structural sliding bearing is therefore always in contact with a portion of the sliding sheet that is supported full-surface by the backing plate during displacements as a result of load cases that occur in the state of use. In other words, the backing plate is dimensioned so large that it fully-faced supports the sliding sheet in the corresponding portion.

In a further execution, the backing plate is dimensioned so large that the sliding plate rests in the limit state of the load-bearing capacity, in particular a limit state of the load-bearing capacity resulting from an earthquake load case, at a maximum lateral displacement partially on a sliding sheet protrusion.

Thus, at least in the ultimate limit state, the sliding plate may also slide onto the sliding sheet protrusion. As a result, the backing plate can be dimensioned smaller, making the structural sliding bearing more compact and cost-effective. This is based on the idea that structural sliding bearings are usually inspected for their condition and any damage after events that correspond to the ultimate limit state, and are repaired or replaced if necessary. Thus, the sliding sheet does not have to be fully supported by the backing plate in the ultimate limit state, as long as it is ensured that the structural sliding bearing does not fail. This can happen, for example, because the sliding plate slips off the sliding sheet completely or because a part of the bearing tilts sideways.

Practically, the backing plate is dimensioned so large that the sliding sheet is fully-surfaced supported by the backing plate to such an extent that a resulting bearing force in the limit state of the load-bearing capacity runs through this part of the backing plate. The backing plate is thus dimensioned so large that the resulting bearing force in the limit state of the load-bearing capacity is introduced via the sliding sheet into the backing plate in such a way that the sliding sheet is fully supported by the backing plate in the area of the resulting bearing force. This ensures that the sliding sheet protrusion is not loaded at a maximum lateral displacement in the limit state of the load-bearing capacity in such a way that the sliding sheet protrusion fails, for example because a slider tilts to the side.

Further executed, at one backing plate is at least one lateral projection to support one of the sliding sheet protrusions, preferably one projection for each sliding sheet protrusion, provided. In the areas of the sliding sheet protrusions projections can therefore be provided to support the sliding sheet. This ensures that the sliding sheet is in contact with the sliding plate even when a force is applied to the sliding sheet protrusion. The projections additionally reduce the deflection of the sliding sheet protrusions when the sliding sheet protrusions are loaded. The backing plate of the structural sliding bearing according to the invention can therefore be dimensioned smaller than the backing plate of a generic structural sliding bearing.

For this purpose, the projection can be connected to the backing plate by a strain press fit assembly, a screw connection, and/or by means of welding. The projection can thus be subsequently attached to the backing plate of the structural sliding bearing. This makes it possible to manufacture the backing plate with projections in a cost-effective manner. It is even conceivable that the displacement capacity of existing bearings can be increased in this way.

Further executed, the structural sliding bearing has a slider. In particular, the slider can be a rigid slider or a jointed slider. Different geometries are conceivable, whereby a calotte is a particularly common shape. In this case, it is a spherical sliding bearing, the structure of which is known per se. A jointed slider allows the backing plates to rotate relative to each other, whereby twisting of the structure can be absorbed in the structural bearing. A structural bearing with a rigid slider, on the other hand, cannot absorb these twists.

Practically, the structural sliding bearing has at least two sliding surfaces. The sliding surfaces can thus be designed for different displacements. This means that the structural sliding bearing can be better designed for a structure. With at least two sliding surfaces, larger displacement capacities can also be implemented, for example.

Further executed, at least one sliding surface has a limiting means for limiting the displacement capacity of the structural sliding bearing. The limiting means can be, for example, a guide rail or a stop. The limiting means limits the displacement of the structural sliding bearing, at least in one direction. Thus, undesired displacements or displacements exceeding a certain value can be prevented.

It may be useful that one sliding surface has a coefficient of friction that differs from that of at least one other sliding surface. For example, one sliding surface can be designed for displacements in the service state, while another sliding surface has a higher coefficient of friction, for example, in order to dissipate additional energy in the case of larger displacements in the ultimate limit state of the load-bearing capacity, in the case of an earthquake.

Further, a sliding surface has a radius of curvature that differs from that of at least one other sliding surface. Different radii of curvature of the sliding surfaces allow the sliding surfaces to be designed for different load cases.

Further executed, a sliding surface has a coefficient of friction that varies along the surface of the sliding plate from the inside (the center of the surface) to the outside (the edge of the surface). The varying coefficient of friction allows friction properties to be designed for different lateral displacements. This means, for example, that the coefficient of friction can increase with increasing displacement and thus more energy can be dissipated with greater displacement, or the other way round, or the coefficient of friction describes any function of the displacement.

Further executed, at least one sliding surface has a radius of curvature that varies from the inside to the outside. Due to the varying radius of curvature of the sliding surface, with increasing displacement the structure is lifted more or less. This means that more or less energy can be dissipated with a larger displacement than with a smaller one.

Preferably, at least one sliding plate has a circular shape in plan view. In particular in such a case, a sliding plate expediently has a radius that differs from that of at least one other sliding plate. A sliding plate can thus have a larger or smaller radius than another sliding plate. By using sliding plates of different sizes, the friction properties of the sliding plates can be designed differently from each other and the structural sliding bearing can thus be individually adapted for a structure.

Further executed, the sliding plate has an inner sliding disc and an outer sliding ring at least partially surrounding said sliding disc. The outer sliding ring, which at least partially surrounds the inner sliding disc, can increase the surface area of the sliding plate. This reduces the wear of the sliding plate, as loads are transferred over a larger area. Furthermore, the inner sliding disc and the outer sliding ring can be replaced independently of each other in case of damage or excessive wear. It is also conceivable that the outer sliding ring partially protrudes beyond the edge of the sliding sheet at a maximum lateral displacement. It is further conceivable that when the bearing moves back from maximum lateral displacement, the outer sliding ring is damaged or torn off without the inner sliding disc being damaged.

It can be advantageous that the outer sliding ring is spaced apart from the inner sliding disc. The distance between the outer sliding ring and the inner sliding disc allows them to deform during lateral displacements without affecting the other of the outer sliding ring and the inner sliding disc. This prevents excessive wear as a result of contact between the inner sliding disc and the outer sliding ring.

Alternatively or additionally, the inner sliding disc has a different coefficient of friction than the outer sliding ring. Due to the different friction values of the inner sliding disc and the outer sliding ring, the sliding properties can be individually designed.

Further executed, the sliding sheet is dimensioned so large that additionally an edge of the sliding sheet is obtained when the sliding plate is displaced up to the maximum displacement capacity. The larger dimensioning of the sliding sheet prevents parts of the sliding plate that, for example, swell out laterally due to deformation of the sliding plate at maximum lateral displacement, from being sheared off by the edge of the sliding sheet. This reduces the wearing of the sliding plate at maximum lateral displacement. Ideally, the edge is completely circumferential.

The sliding sheet can be linked by force-fit and/or by form-fit with the backing plate. This can be done in particular in such a way that the sliding sheet is partially recessed into the backing plate. The recess thus only partially encompasses the circumference of the sliding sheet. The partial recessing makes it possible, for example, to dimension the backing plate smaller than the sliding sheet and to provide sliding sheet protrusions on the sliding sheet. Investigations have shown that a partial recessing of the sliding sheet is sufficient to securely fasten the sliding sheet to the backing plate. The recess can consist of a number of sections arranged around the sliding sheet or of one continuous section.

Alternatively or further executed, the sliding sheet is fastened to the backing plate by means of at least one fastening means such as nails, welded connections, screws, adhesive joints, retaining bolts and/or by a bolt which projects into a recess of the backing plate, the recess preferably being as accurately as possible. By fastening the sliding sheet to the backing plate with one of the aforementioned fastening means or by a combination of at least two of the aforementioned fastening means, sliding of the sliding sheet is prevented. These can be used if, for example, the chambering of the sliding sheet is insufficient for fixing alone or if there is no chambering. This ensures that the structural sliding bearing has the sliding properties according to the design and that the sliding sheet is not displaced as a result of the action of a force or a load case.

In the following, the invention is explained in more detail with reference to examples of embodiments shown in the drawings. Therein, schematically shown is:

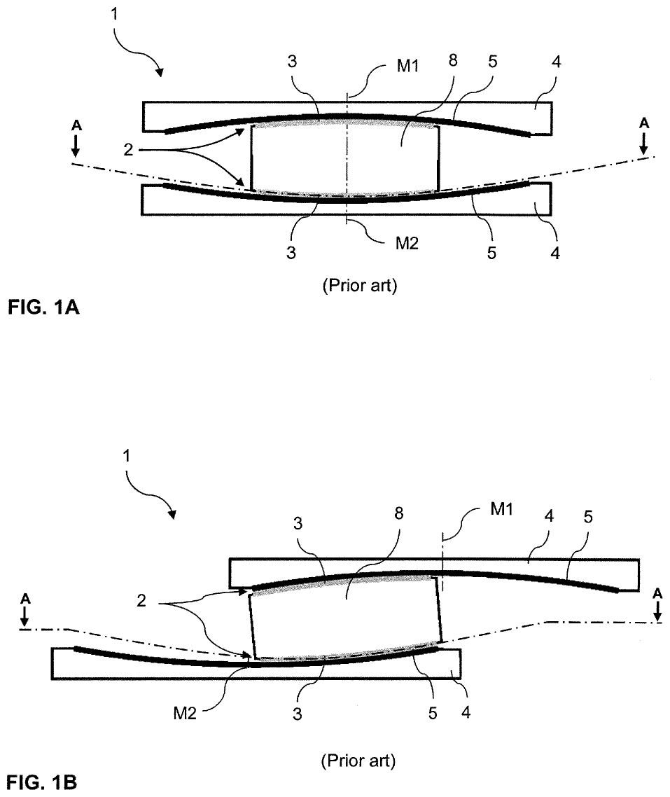

FIG. 1A a sectional view through a generic structural sliding bearing in centered position;

FIG. 1B a sectional view through the structural sliding bearing shown in FIG. 1A in the state of maximum lateral displacement in the ultimate limit state;

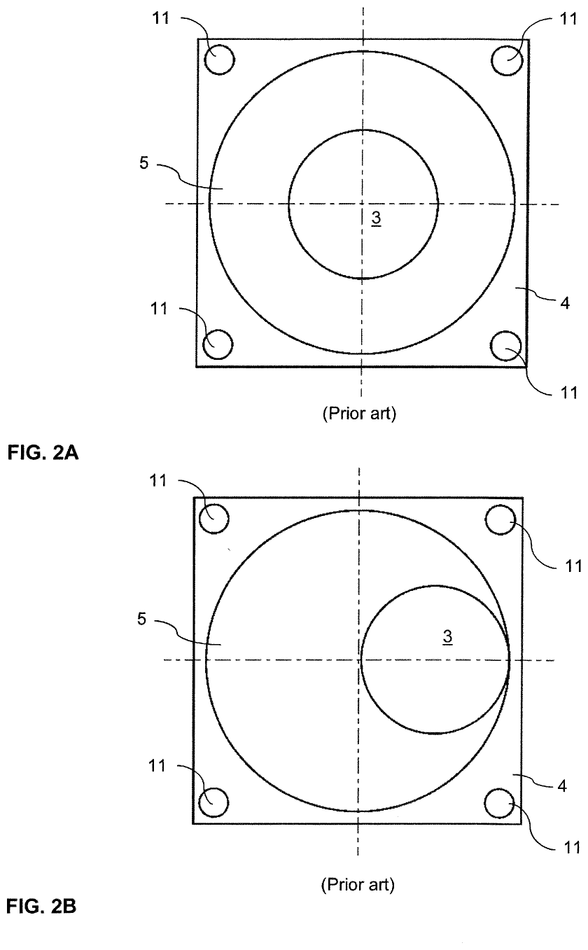

FIG. 2A a sectional view through the structural sliding bearing shown in FIG. 1A along the sectional plane A-A;

FIG. 2B a sectional view through the structural sliding bearing shown in FIG. 1B along the sectional plane A-A;

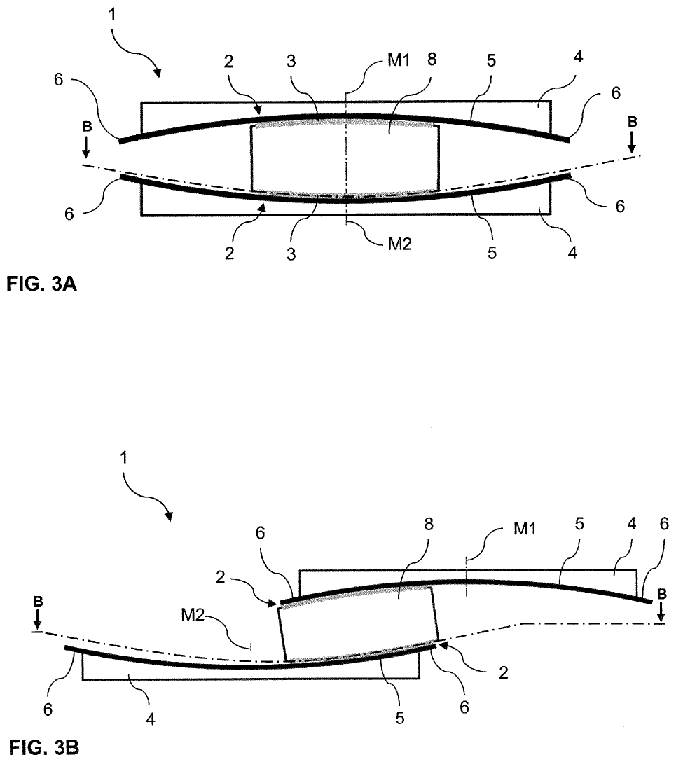

FIG. 3A a sectional view through a first embodiment of a structural sliding bearing according to the invention in centered position;

FIG. 3B a sectional view through the structural sliding bearing shown in FIG. 3A in the state of maximum lateral displacement in the ultimate limit state;

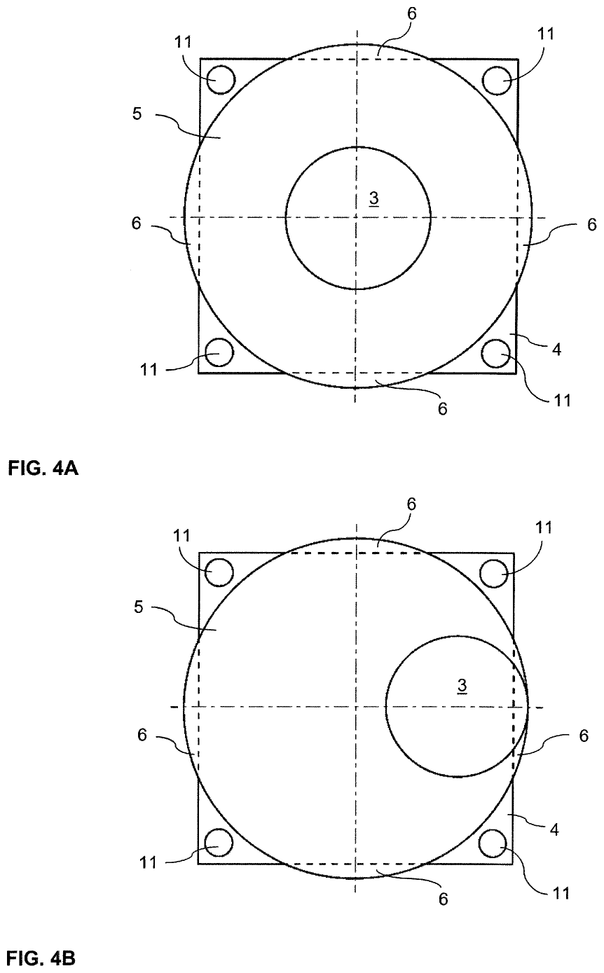

FIG. 4A a sectional view through the structural sliding bearing shown in FIG. 3A along the sectional plane B-B;

FIG. 4B a sectional view through the structural sliding bearing shown in FIG. 3B along the sectional plane B-B;

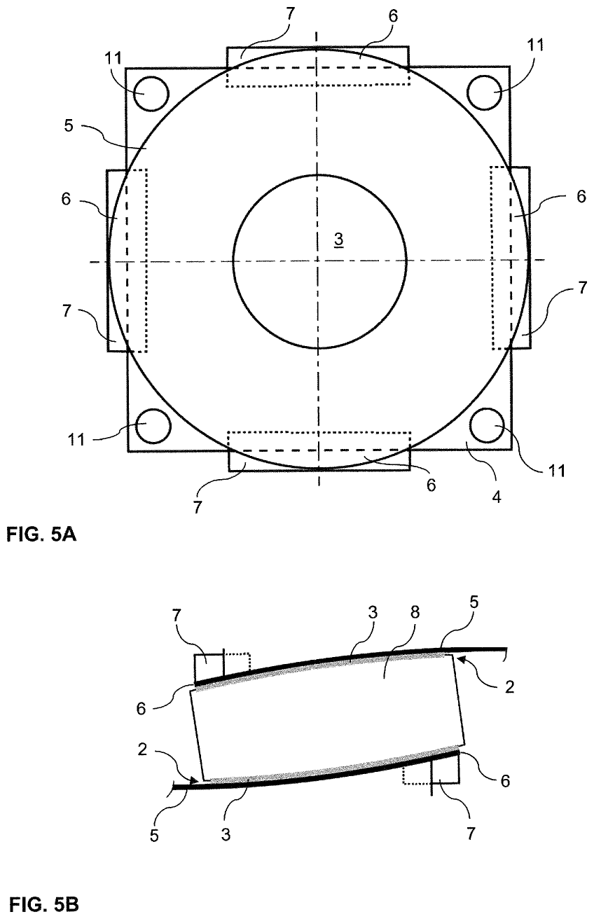

FIG. 5A a sectional view through a structural sliding bearing according to a second embodiment of the invention with projections in centered position;

FIG. 5B a sectional view through the structural sliding bearing shown in FIG. 5A in the state of maximum lateral displacement in the ultimate limit state;

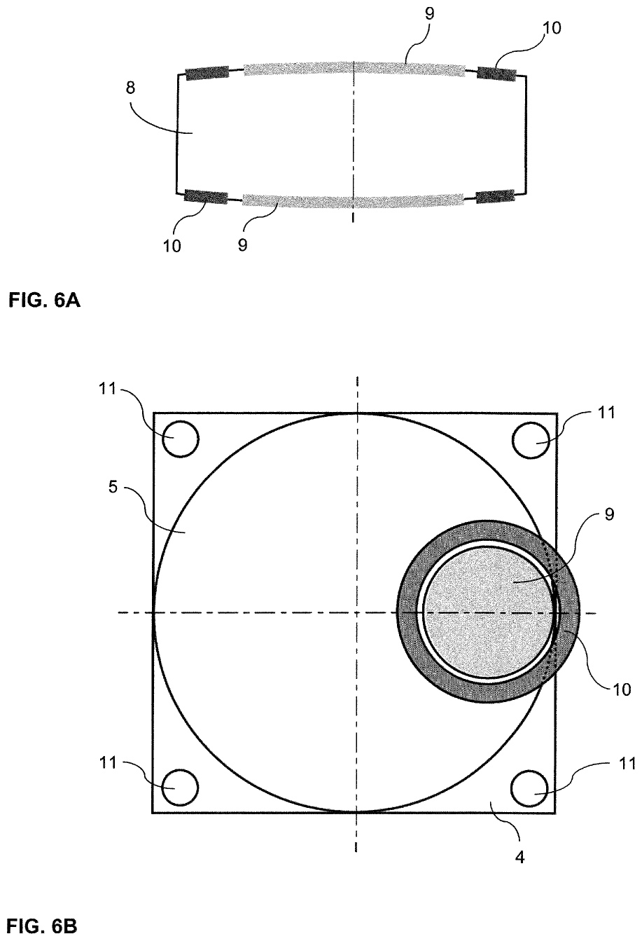

FIG. 6A a sectional view through a slider of a third embodiment with an inner sliding disc and an outer sliding ring surrounding the inner sliding disc;

FIG. 6B a sectional view through a structural sliding bearing of a third embodiment with the slider shown in FIG. 6A in the state of maximum lateral displacement in the ultimate limit state;

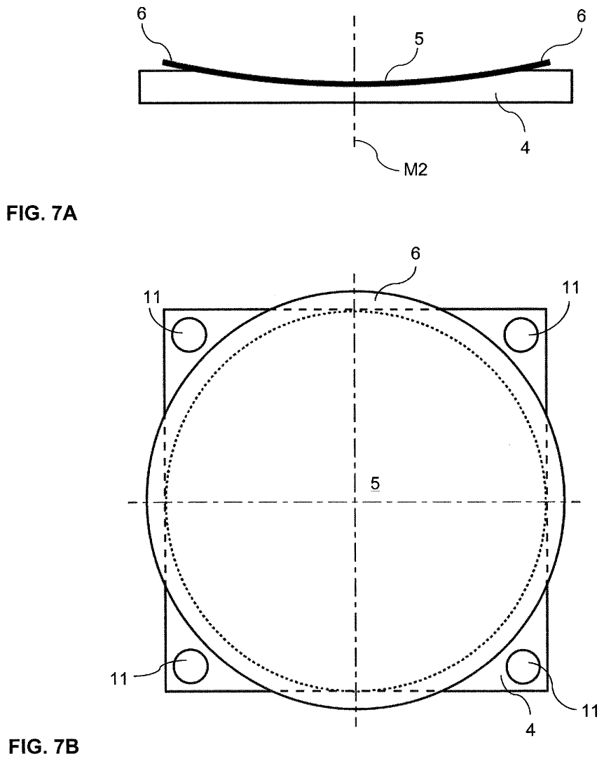

FIG. 7A a sectional view through a backing plate with a sliding sheet with sliding sheet protrusion of a structural sliding bearing of a fourth embodiment according to the invention; and

FIG. 7B a top view of the backing plate shown in FIG. 7A with a sliding sheet with sliding sheet protrusion.

Similar components or elements are given the same reference signs in the figures.

FIGS. 1A to 2B show sections of a generic structural sliding bearing 1 known per se from the prior art in centered position (FIG. 1A and FIG. 2A) and with maximum displacement in the ultimate limit state (FIG. 1B and FIG. 2B).

The generic structural sliding bearing 1 consists of two backing plates 4 arranged one above the other, each of which has four recesses 11 for fastening to the structure, with which the backing plates 4 are fastened to the structure. A sliding sheet 5 is attached to each of the backing plates 4. In the present example, the sliding sheets 5 have a circular shape and are concave. Each sliding sheet 5 has a central axis M which passes through the center of the sliding sheet 5. The backing plates 4 are arranged so that the surfaces of the sliding sheets 5 face each other. A slider 8 is arranged between the sliding sheets 5. The slider 8 has two convex surfaces, to each of which a convex sliding plate 3 is attached. The radii of curvature of the concave sliding sheets 5 and the convex sliding plates 3 are designed in such a way that the surfaces of the sliding plates 3 are in full-surface contact with the corresponding sliding sheets 5. The sliding plates 3 are each in sliding contact with a sliding sheet 5 and form a sliding surface 2 with the sliding sheets 5.

FIGS. 1A and 2A show the structural sliding bearing 1 in centered position. FIG. 2A shows a section along the sectional plane A-A of FIG. 1A. Therein, the slider 8 is arranged in a centered position between the backing plates 4. In the centered position, the central axis of the upper sliding sheet M1, the central axis of the lower sliding sheet M2 and the vertical axis of the slider 8 coincide.

FIGS. 1B and 2B show the structural sliding bearing 1 along the sectional plane in the ultimate limit state. Here, the slider 8 is displaced laterally to the maximum extent so that the maximum displacement capacity of the structural sliding bearing 1 is utilized. At the maximum displacement, the sliding plate 3 on the slider 8 is displaced on the sliding sheet 5 to such an extent that the edge of the sliding plate 3 touches the edge of the sliding sheet 5, but the sliding plate 3 is still in full-surface contact with the sliding sheet 5. Due to the geometry of the slider 8 and the sliding sheets 5, the distance between the backing plates 4 is greater at the maximum displacement of the structural sliding bearing 1 than in the centered position.

FIGS. 3A and 4A show a structural sliding bearing 1 according to the invention in centered position. Unlike the generic structural sliding bearing 1 shown in FIGS. 1A and 2A, the sliding sheets 5 have sliding sheet protrusions 6 at the edge which project laterally beyond the backing plates 4. As can be seen in FIGS. 4A and 4B, the sliding sheet protrusions 6 are only formed in four partial areas of the circumferential line of the sliding sheet 5. The sliding sheet 5 therefore does not protrude completely beyond the backing plate 4.

Due to the sliding sheet protrusions 6, the slider 8 can be partially displaced over the edge of the backing plate 4 in the limit state of the load-bearing capacity, which is shown in FIGS. 3B and 4B. However, this only to the extent that the sliding plates 3 of the slider 8 are nevertheless in full-surface contact with the sliding sheets 5. The displacement capacity of the structural sliding bearing 1 according to the invention in FIGS. 3A to 4B is thus greater than the displacement capacity of the generic structural sliding bearing 1 in FIGS. 1A to 2B and the backing plates 4 are of the same dimension. Or, if the sliding sheets 5 are of the same size, the backing plate 4 can be dimensioned smaller than before.

In the second exemplary embodiment of a structural sliding bearing 1 according to the invention shown in FIG. 5A, the structural sliding bearing 1 is in a centered position. In contrast to the first exemplary embodiment shown in FIG. 4A, the structural sliding bearing 1 of the second exemplary embodiment has a projection 7 for each sliding sheet protrusion 6, which are provided laterally on the backing plate 4 and support the sliding sheet protrusions 6 full-surface.

FIG. 5B shows a section through the structural sliding bearing 1 of the second embodiment of FIG. 5A, which is in the limit state of load-bearing capacity and is displaced laterally to the maximum. The sliding plates 3 attached to the slider 8 are in full-surface contact with the sliding sheet 5, which is supported at the sliding sheet protrusions 6 by the projections 7.

A slider 8 of a third embodiment of the structural sliding bearing 1 according to the invention is shown in FIG. 6A. The sliding plates 3 provided on the slider 8 each consist of an inner sliding disc 9 and an outer sliding ring 10 which surrounds the inner sliding disc. The outer sliding ring 10 is arranged spaced apart from the inner sliding disc 9.

FIG. 6B shows a structural sliding bearing 1 of the third embodiment with maximum lateral displacement in the ultimate limit state. Here, the edge of the inner sliding disc 9 touches the edge of the sliding sheet 5 in such a way that the inner sliding disc 9 is in full-surface contact with the sliding sheet 5 and is supported full-surface by the backing plate 4. The outer sliding ring 10, which surrounds the inner sliding disc 9, thus partially displaces beyond the edge of the sliding sheet 5. Thus, a crescent-shaped part of the outer sliding ring 10 is no longer in contact with the sliding sheet 5, but is located outside the sliding sheet 5 without support.

FIG. 7A shows a backing plate 4 with a sliding sheet 5 of a third embodiment. This embodiment also has sliding sheet protrusions 6, but these are designed in such a way that they are located completely above the backing plate 4, but are not supported by it. The sliding sheet protrusion 6 of the third embodiment may also be a single sliding sheet protrusion 6 enclosing the entire sliding sheet 5.

FIG. 7B shows a top view of a backing plate 4 of such an embodiment in which a sliding sheet protrusion 6 surrounds the sliding sheet 5 and the sliding sheet protrusion 6 is not supported by the backing plate 4.

### REFERENCE SIGNS

1 Structural sliding bearing
2 Sliding surface
3 Sliding plate
4 Backing plate
5 Sliding sheet
6 Sliding sheet protrusion
7 Lateral projection
8 Slider
9 Inner sliding ring
10 Outer sliding ring
11 Recess for fastening the structural sliding bearing
M1 Central axis of the upper sliding sheet
M2 Central axis of the lower sliding sheet

1. A structural sliding bearing having at least one sliding surface with a sliding plate and a mating surface which are in sliding contact so that the sliding plate can move relative to the at least one mating surface, and the mating surface is arranged on a backing plate, wherein the mating surface is formed as a sliding sheet,
characterized in that
the sliding sheet has a sliding sheet protrusion by which the sliding sheet hangs or stands at its edge over the backing plate, such that the sliding sheet is not completely supported by the backing plate,
and that
at least one sliding surface is spherically curved.

2. The structural sliding bearing according to claim 1,
characterized in that
the structural sliding bearing is formed as an earthquake protection device and has at least two spherically curved sliding surfaces.

3. The structural sliding bearing according to claim 1,
characterized in that
the backing plate is dimensioned so large that, in the serviceability limit state of the structural sliding bearing, the sliding plate is in full-surface contact with a portion of the sliding sheet in the event of a maximum lateral displacement, in which portion the sliding sheet is still fully-surfaced supported by the backing plate.

4. The structural sliding bearing according to claim 1,
characterized in that
the backing plate is dimensioned so large that the sliding plate, in the ultimate limit state of the load-bearing capacity, in particular a limit state of the load-bearing capacity from an earthquake load case, is partially located on a sliding sheet protrusion with a maximum lateral displacement.

5. The structural sliding bearing according to claim 4,
characterized in that
the backing plate is dimensioned so large that the sliding sheet is supported by the backing plate at the position of a resulting vertical load.

6. The structural sliding bearing according to claim 1,
characterized in that
at least one lateral projection is provided on a backing plate to support one of the sliding sheet protrusions; or
at least one lateral projection is provided on a backing plate to support one of the sliding sheet protrusions with one projection for each sliding sheet protrusion.

7. The structural sliding bearing according to claim 6,
characterized in that
the projection is connected to the backing plate by an expansion joint, a screw connection and/or by means of welding.

8. The structural sliding bearing according to claim 1,
characterized in that
the structural sliding bearing has a slider or a slider which is rigid or jointed in itself.

9. The structural sliding bearing according to claim 1,
characterized in that
the structural sliding bearing has at least two sliding surfaces.

10. The structural sliding bearing according to claim 1,
characterized in that
at least one sliding surface has a limiting means for limiting the displacement capacity of the structural sliding bearing.

11. The structural sliding bearing according to claim 1,
characterized in that
a sliding surface has a coefficient of friction that differs from at least one other sliding surface.

12. The structural sliding bearing according to claim 1,
characterized in that
a sliding surface has a radius of curvature that differs from at least one other sliding surface.

13. The structural sliding bearing according to claim 1,
characterized in that
at least one sliding surface has a coefficient of friction which varies from the inside to the outside along the surface of the sliding plate.

14. The structural sliding bearing according to claim 11,
characterized in that
at least one sliding surface has a radius of curvature that varies from the inside to the outside.

15. The structural sliding bearing according to claim 1,
characterized in that
at least one sliding plate has a circular shape in plan view.

16. The structural sliding bearing according to claim 1,
characterized in that
a sliding plate has a radius which is different from at least one other sliding plate.

17. The structural sliding bearing according to claim 1,
characterized in that
the sliding plate has an inner sliding disc and an outer sliding ring at least partially surrounding this sliding disc.

18. The structural sliding bearing according to claim 16,
characterized in that
the outer sliding ring is spaced apart from the inner sliding disc.

19. The structural sliding bearing according to claim 1,
characterized in that
a sliding plate has a radius which is different from at least one other sliding plate or the sliding plate has an inner sliding disc and an outer sliding ring at least partially surrounding this sliding disc, and
further characterized in that
the inner sliding disc has a different coefficient of friction than the outer sliding ring.

20. The structural sliding bearing according to claim 1,
characterized in that
the sliding sheet is dimensioned so large that an additional edge of the sliding sheet results when the sliding plate is displaced up to the maximum displacement capacity.

21. The structural sliding bearing according to claim 1,
characterized in that
the sliding sheet is linked to the backing plate by force-fit and/or form-fit.

22. The structural sliding bearing according to claim 1,
characterized in that
the sliding sheet is partially recessed into the backing plate.

23. The structural sliding bearing according to claim 1,
characterized in that
the sliding sheet is dimensioned so large that an additional edge of the sliding sheet results when the sliding plate is displaced up to the maximum displacement capacity or the sliding sheet is linked to the backing plate by force-fit and/or form-fit, and
further characterized in that
the sliding sheet is fastened to the backing plate by means of at least one fastening means such as nails, welded connections, screws, adhesive connections, retaining bolts and/or by a bolt which projects into a recess of the backing plate.
